(19) United States
(12) Patent Application Publication
(10) Pub. No.: US 2018/0163810 A1
(43) Pub. Date: Jun. 14, 2018

(54) PISTON

(71) Applicant: KYB Corporation, Tokyo (JP)

(72) Inventors: Takahiro KIYONAGA, Gifu (JP); Shotaro ASAOKA, Gifu (JP)

(73) Assignee: KYB Corporation, Tokyo (JP)

(21) Appl. No.: 15/738,251

(22) PCT Filed: Jul. 22, 2015
(86) PCT No.: PCT/JP2015/070827

§ 371 Date: Dec. 20, 2017

(51) Int. Cl. F16F 9/32; F16F 9/512; F16F 9/516; F16F 9/348

(52) U.S. Cl. CPC F16F 9/3214; F16F 9/5126; F16K 15/148; F16F 9/3482; F16F 9/5165

(57) ABSTRACT

A piston includes a plurality of ports formed along a circumferential direction of the piston, the ports penetrating in an axial direction of the piston, and a plurality of seat surfaces, on which a disc valve is seated, formed to surround an opening of each port on one end surface of the piston, the disc valve being configured to open and close the ports, wherein each port is defined by an arc-shaped inner peripheral surface, an arc-shaped outer peripheral surface that is longer in a circumferential direction than the inner peripheral surface, and two side surfaces that connect the inner peripheral surface and the outer peripheral surface, and at least two protrusions are provided to the outer peripheral surface of each port, the protrusions protruding toward the inside of the port and extending in the axial direction up to the seat surface.

### TECHNICAL FIELD

The present invention relates to a piston for a damper.

### BACKGROUND ART

U.S. Pat. No. 6,401,755B2 discloses a piston for a damper in which the cross-section shape of a port is a trapezoidal shape (fan shape).

### SUMMARY OF INVENTION

In the above-described piston, the cross-section area of the port, i.e. the area of a flow passage through which a working fluid passes, can be increased, and thus the damping force characteristics of the damper can be improved.

However, if the cross-section area of the port is increased, a seat surface on which a disc valve that opens and closes the port sits also expands. When the damper operates in the direction in which the disc valve closes the port, a pressure acts on the back surface of the disc valve. Therefore, if the seat surface on which the disc valve that opens and closes the port sits expands, bending of the disc valve increases and this leads to a problem of an increase in the stress generated in the disc valve.

An object of the present invention is to increase the cross-section area of the port while reducing the stress generated in the disc valve.

According to one aspect of the present invention, an annular piston for a damper, the piston includes a plurality of ports formed along a circumferential direction of the piston, the ports penetrating in an axial direction of the piston, and a plurality of seat surfaces, on which a disc valve is seated, formed to surround an opening of each port on one end surface of the piston, the disc valve being configured to open and close the ports, wherein each port is defined by an arc-shaped inner peripheral surface, an arc-shaped outer peripheral surface that is longer in a circumferential direction than the inner peripheral surface, and two side surfaces that connect the inner peripheral surface and the outer peripheral surface, and at least two protrusions are provided to the outer peripheral surface of each port, the protrusions protruding toward the inside of the port and extending in the axial direction up to the seat surface.

### BRIEF DESCRIPTION OF DRAWINGS

FIG. 1 is a cross-section view of a damper according to an embodiment of the present invention.

FIG. 2 illustrates a piston when viewed from an extension-side chamber side.

FIG. 3 is a cross-section view along line III-III in FIG. 2.

### DESCRIPTION OF EMBODIMENTS

A damper 100 according to an embodiment of the present invention will now be explained below while referring to the attached drawings.

The damper 100 is, for example, a device that is interposed between a vehicle body and an axle of an automobile (not illustrated), and that generates a damping force to suppress vibrations of the vehicle body.

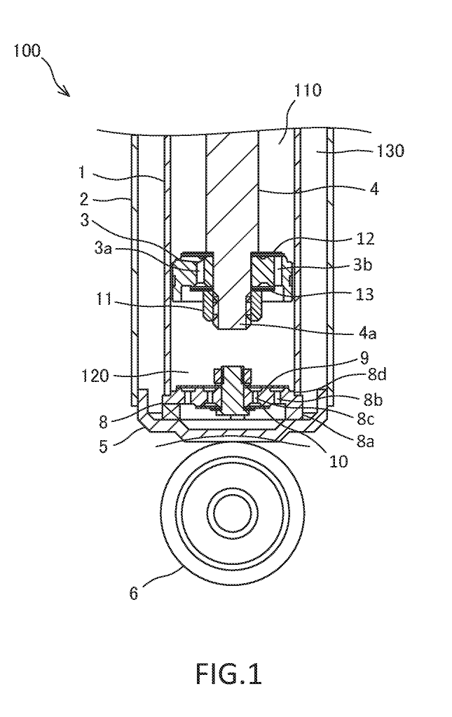

As shown in FIG. 1, the damper 100 includes the following: an inner tube 1 which serves as a cylinder that is filled with a hydraulic oil which serves as a working fluid; an outer tube 2 that is disposed so as to cover the inner tube 1; a piston 3 that is slidably inserted into the inner tube 1 and partitions the inside of the inner tube 1 into an extension-side chamber 110 and a contraction-side chamber 120; and a piston rod 4 that is connected to the piston 3 and inserted into the inner tube 1 such that the piston rod 4 can move into and out of the inner tube 1.

A reservoir 130 that stores the hydraulic oil is formed between the inner tube 1 and the outer tube 2. The hydraulic oil is stored in the reservoir 130, and a compressed gas for preventing cavitation of the hydraulic oil, etc. is also sealed in the reservoir 130.

The end of the outer tube 2 on the contraction-side chamber 120 side, which is the bottom side of the outer tube 2, is closed by a bottom member 5. The bottom member 5 is fixed by welding to the outer tube 2. A connection member 6 for attaching the damper 100 to a vehicle is provided to the bottom member 5.

A rod guide (not illustrated) that slidably supports the piston rod 4 and an oil seal (not illustrated) for preventing the hydraulic oil and the compressed gas from leaking to the outside of the damper 100 are provided to the end of the inner tube 1 on the extension-side chamber 110 side. A base member 8 that partitions the contraction-side chamber 120 and the reservoir 130 is provided to the end of the inner tube 1 on the contraction-side chamber 120 side, which is the bottom side of the inner tube 1.

The base member 8 includes: a plurality of legs 8a that are formed on the outer peripheral side of the surface on the bottom member 5 side and that abut the bottom member 5; an extension-side port 8b and a contraction-side port 8c that establish communication between the contraction-side chamber 120 and the reservoir 130; and a press-fitting part 8d formed on the outer peripheral side. The base member 8 is press-fitted into the inner tube 1 by the press-fitting part 8d.

A disc valve 9 that opens and closes the extension-side port 8b is disposed on the contraction-side chamber 120 side of the base member 8, and a disc valve 10 that opens and closes the contraction-side port 8c is disposed on the reservoir 130 side of the base member 8.

The disc valve 9 is a check valve, and the disc valve 9 is opened by the pressure difference between the contraction-side chamber 120 and the reservoir 130 during the extension operation of the damper 100, thereby opening the extension-side port 8b. The disc valve 9 closes the extension-side port 8b during the contraction operation of the damper 100.

The disc valve 10 is opened by the pressure difference between the contraction-side chamber 120 and the reservoir 130 during the contraction operation of the damper 100, thereby opening the contraction-side port 8c. Further, the disc valve 10 applies resistance to the flow of hydraulic oil moving from the contraction-side chamber 120 to the reservoir 130 via the contraction-side port 8c. The disc valve 10 closes the contraction-side port 8c during the extension operation of the damper 100.

A small-diameter part 4a, which is smaller in diameter than the outer diameter of the piston rod 4 and is inserted into the piston 3, is formed on the end of the piston rod 4 on the piston 3 side. Male threads are formed on the small-diameter part 4a, and the piston rod 4 and the piston 3 are connected by a nut 11.

The piston 3 has an extension-side port 3a and a contraction-side port 3b that establish communication between the extension-side chamber 110 and the contraction-side chamber 120. A disc valve 12 that opens and closes the contraction-side port 3b is disposed on the extension-side chamber 110 side of the piston 3, and a disc valve 13 that opens and closes the extension-side port 3a is disposed on the contraction-side chamber 120 side of the piston 3. The piston 3 will be explained in further detail below.

The disc valve 12 is opened by the pressure difference between the extension-side chamber 110 and the contraction-side chamber 120 during the contraction operation of the damper 100, thereby opening the contraction-side port 3b. Further, the disc valve 12 applies resistance to the flow of hydraulic oil moving from the contraction-side chamber 120 to the extension-side chamber 110 via the contraction-side port 3b. The disc valve 12 closes the contraction-side port 3b during the extension operation of the damper 100.

The disc valve 13 is opened by the pressure difference between the extension-side chamber 110 and the contraction-side chamber 120 during the extension operation of the damper 100, thereby opening the extension-side port 3a. Further, the disc valve 13 applies resistance to the flow of hydraulic oil moving from the extension-side chamber 110 to the contraction-side chamber 120 via the extension-side port 3a. The disc valve 13 closes the extension-side port 3a during the contraction operation of the damper 100.

During the extension operation of the damper 100 in which the piston rod 4 moves out of the inner tube 1, hydraulic oil moves from the extension-side chamber 110, the capacity of which decreases due to the movement of the piston 3, to the contraction-side chamber 120, the capacity of which increases due to the movement of the piston 3, via the extension-side port 3a. Further, hydraulic oil in an amount equivalent to the volume of the piston rod 4 which has moved out of the inner tube 1 is supplied from the reservoir 130 to the contraction-side chamber 120 via the extension-side port 8b.

At this time, as discussed above, the damper 100 applies resistance by means of the disc valve 13 to the flow of hydraulic oil passing through the extension-side port 3a, and generates a pressure difference between the extension-side chamber 110 and the contraction-side chamber 120 so as to generate a damping force.

During the contraction operation of the damper 100 in which the piston rod 4 moves into the inner tube 1, hydraulic oil moves from the contraction-side chamber 120, the capacity of which decreases due to the movement of the piston 3, to the extension-side chamber 110, the capacity of which increases due to the movement of the piston 3, via the contraction-side port 3b. Further, hydraulic oil in an amount equivalent to the volume of the piston rod 4 which has moved into the inner tube 1 is discharged from the contraction-side chamber 120 to the reservoir 130 via the contraction-side port 8c.

At this time, as discussed above, the damper 100 applies resistance by means of the disc valve 12 and the disc valve 10 to the flow of hydraulic oil passing through the contraction-side port 3b and the contraction-side port 8c, and generates a pressure difference between the extension-side chamber 110 and the contraction-side chamber 120 so as to generate a damping force.

As discussed above, hydraulic oil is supplied from the reservoir 130 to the contraction-side chamber 120 during the extension operation of the damper 100, and hydraulic oil is discharged from the contraction-side chamber 120 to the reservoir 130 during the contraction operation of the damper 100. Thereby, the change in capacity within the inner tube 1 is compensated.

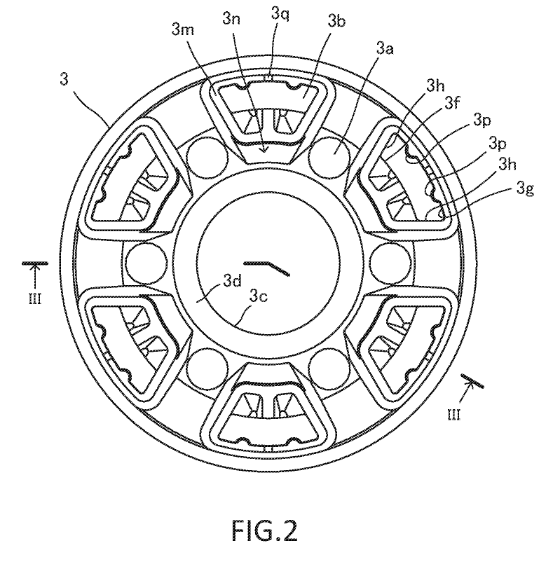

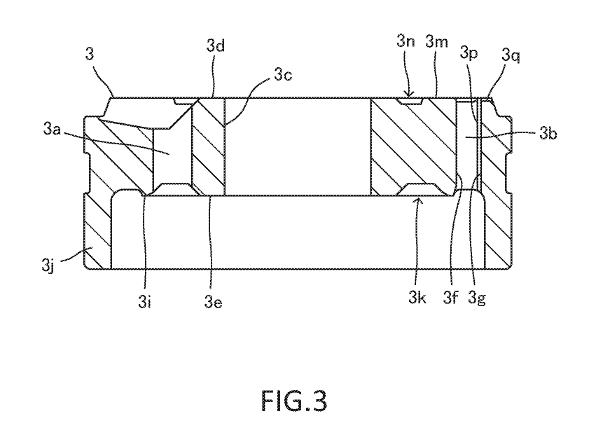

Next, the piston 3 will be explained in detail referring to FIGS. 2 and 3.

FIG. 2 illustrates the piston 3 when viewed from the extension-side chamber side, and FIG. 3 is a cross-section view along line III-III in FIG. 2.

The piston 3 includes: a through-hole 3c into which the piston rod 4 is inserted; an extension-side inner seat surface 3d that is formed on the periphery of the through-hole 3c at the end surface on the extension-side chamber 110 side; and a contraction-side inner seat surface 3e that is formed on the periphery of the through-hole 3c at the end surface on the contraction-side chamber 120 side (refer to FIG. 3).

When the piston 3 is connected to the piston rod 4 by the nut 11, as shown in FIG. 1, the inner peripheral side of the disc valve 12 is clamped between the extension-side inner seat surface 3d and the piston rod 4, and the inner peripheral side of the disc valve 13 is clamped between the contraction-side inner seat surface 3e and the nut 11.

As shown in FIG. 2, each extension-side port 3a has a circular cross-section, and the extension-side ports 3a are formed at six locations spaced apart equally in the circumferential direction of the piston 3 more toward the outer peripheral side of the piston 3 than the extension-side inner seat surface 3d and the contraction-side inner seat surface 3e.

Each contraction-side port 3b is defined along the circumferential direction of the piston 3 by an arc-shaped inner peripheral surface 3f, an arc-shaped outer peripheral surface 3g that is longer in the circumferential direction than the inner peripheral surface 3f, and two side surfaces 3h that connect the inner peripheral surface 3f and the outer peripheral surface 3g.

The contraction-side ports 3b are provided at six locations spaced apart equally in the circumferential direction of the piston 3 so as to alternate with the extension-side ports 3a, and the contraction-side ports 3b are formed more toward the outer peripheral side of the piston 3 than a pitch circle that passes through the center of the six extension-side ports 3a.

As shown in FIG. 3, an annular contraction-side outer seat surface 3i on which the disc valve 13 sits is formed between the extension-side ports 3a and the contraction-side ports 3b at the end surface on the contraction-side chamber 120 side of the piston 3. Further, a cylindrical part 3j that is continuous from the outer peripheral surface is formed on the outer peripheral side at the end surface on the contraction-side chamber 120 side of the piston 3.

A portion that opposes an annular passage 3k between the contraction-side inner seat surface 3e and the contraction-side outer seat surface 3i in a state in which the disc valve 13 is seated on the contraction-side outer seat surface 3i serves as a pressure-receiving surface of the disc valve 13 until the disc valve 13 opens during the extension operation of the damper 100.

On the end surface on the extension-side chamber 110 side of the piston 3, extension-side seat surfaces 3m that surround the openings of the six contraction-side ports 3b are formed.

A portion that opposes a space on the inside of each extension-side seat surface 3m in a state in which the disc valve 12 is seated on the extension-side seat surfaces 3m serves as a pressure-receiving surface of the disc valve 12 until the disc valve 12 opens during the contraction operation of the damper 100.

The extension-side seat surfaces 3m are provided so as to be spaced apart from the extension-side inner seat surface 3d. Thereby, an annular passage 3n that connects the openings on the extension-side chamber 110 side of the six extension-side ports 3a is formed between the extension-side seat surfaces 3m and the extension-side inner seat surface 3d.

In the present embodiment, two protrusions 3p are provided on the outer peripheral surface 3g of each contraction-side port 3b.

As shown in FIG. 3, the protrusions 3p protrude toward the inside of the contraction-side port 3b and extend in the axial direction up to the extension-side seat surface 3m. In other words, the ends on the extension-side seat surface 3m side of the protrusions 3p form a portion of the extension-side seat surface 3m as shown in FIG. 2.

The two protrusions 3p are provided symmetrically relative to the center in the circumferential direction of the outer peripheral surface 3g. A notch 3q is provided between the two protrusions 3p on the extension-side seat surface 3m so as to form an orifice passage between the notch 3q and the disc valve 12. The notch 3q is formed by, for example, coining. The notch 3q does not have to be provided if it is not necessary.

Next, the operational effects achieved by configuring the damper 100 as described above will be explained.

As described above, during the extension operation, the damper 100 applies resistance by means of the disc valve 13 to the flow of hydraulic oil passing through the extension-side port 3a, and generates a pressure difference between the extension-side chamber 110 and the contraction-side chamber 120 so as to generate a damping force. Further, during the contraction operation, the damper 100 applies resistance by means of the disc valve 13 and the disc valve 10 to the flow of hydraulic oil passing through the contraction-side port 3b and the contraction-side port 8c, and generates a pressure difference between the extension-side chamber 110 and the contraction-side chamber 120 so as to generate a damping force.

In this kind of damper, the damping force characteristics can be improved by increasing the cross-section area of the port, i.e. by increasing the area of the flow passage through which the working fluid passes.

Thus, in the damper 100 according to the present embodiment, each contraction-side port 3b of the piston 3 is defined along the circumferential direction of the piston 3 by the arc-shaped inner peripheral surface 3f, the arc-shaped outer peripheral surface 3g that is longer in the circumferential direction than the inner peripheral surface 3f, and the two side surfaces 3h that connect the inner peripheral surface 3f and the outer peripheral surface 3g. Thereby, the cross-section area of the contraction-side port 3b is increased.

However, if the cross-section area of the contraction-side port 3b is increased, the extension-side seat surface 3m, which is provided so as to surround the contraction-side port 3b, also expands. During the extension operation of the damper 100 in which the disc valve 12 closes the contraction-side ports 3b, the pressure of the extension-side chamber 110 acts on the back surface of the disc valve 12. Therefore, if the extension-side seat surfaces 3m on which the disc valve 12 sits expand, bending of the disc valve 12 increases and this leads to an increase in the stress generated in the disc valve 12.

In response to the above, in the present embodiment, the two protrusions 3p that extend up to the extension-side seat surface 3m are provided to the outer peripheral surface 3g of each contraction-side port 3b as described above. Therefore, during the extension operation of the damper 100, the disc valve 12 is supported by the two protrusions 3p that protrude toward the inside of each contraction-side port 3b.

Due to this configuration, bending of the disc valve 12 can be suppressed compared to the case in which the protrusions 3p are not provided, and thus the stress generated in the disc valve 12 can be reduced. Further, since this configuration consists of merely providing the protrusions 3p, the cross-section area of the contraction-side ports 3b is not significantly reduced. Thus, the cross-section area of the contraction-side ports 3b can be increased while reducing the stress generated in the disc valve 12.

Since two of the protrusions 3p are provided, the area of stress concentration in the disc valve 12 can be dispersed to the portions that abut the two protrusions 3p, and the maximum stress that is generated in these portions that abut the protrusions can be decreased.

In particular, in the present embodiment, the two protrusions 3p are provided symmetrically relative to the center in the circumferential direction of the outer peripheral surface 3g. Due to this configuration, the stress generated in each of the portions of the disc valve 12 that abut the two protrusions 3p can be made approximately equal. Therefore, the maximum stress that is generated in the portions of the disc valve 12 that abut the protrusions 3p can be decreased to the maximum degree.

Considering the stability of the orifice characteristics, the notch 3q forming the orifice passage is preferably formed at the center in the circumferential direction of each contraction-side port 3b. However, if there is a protrusion 3p at the center of the outer peripheral surface 3g or a position corresponding to the center of the outer peripheral surface 3g, the notch 3q and the protrusion 3p may overlap. In this case, variations in the passage length or passage shape of the orifice passage occur easily, and it may be difficult to stabilize the orifice characteristics.

In response to the above, in the present embodiment, the two protrusions 3p are provided symmetrically relative to the center in the circumferential direction of the outer peripheral surface 3g, and the notch 3q is provided between the two protrusions 3p on the extension-side seat surface 3m. Therefore, there is no overlap between the notch 3q and the protrusions 3p. Thus, variations in the passage length or passage shape of the orifice passage can be prevented, and the orifice characteristics can be stabilized.

In the present embodiment, two protrusions 3p are provided to each contraction-side port 3b. However, three or more protrusions 3p may be provided. However, if the notch 3q is to be provided to the extension-side seat surface 3m, it is preferable to set the number of protrusions 3p to an even number and to provide the protrusions 3p symmetrically relative to the center of the outer peripheral surface 3g. Thereby, overlap between the notch 3q and the protrusions 3p can be prevented as mentioned above.

The configuration, action, and effects of this embodiment of the present invention will now be explained below.

The annular piston 3 used in the damper 100 includes the following: the plurality of contraction-side ports 3b which penetrate in the axial direction and which are formed along the circumferential direction of the piston 3; and the extension-side seat surfaces 3m which are formed to surround the openings of the contraction-side ports 3b respectively at the end surface on the extension-side chamber 110 side of the piston 3, and on which the disc valve 12 that opens and closes the contraction-side ports 3b sits. Each contraction-side port 3b is defined by the arc-shaped inner peripheral surface 3f, the arc-shaped outer peripheral surface 3g that is longer in the circumferential direction than the inner peripheral surface 3f, and the two side surfaces 3h that connect the inner peripheral surface 3f and the outer peripheral surface 3g. Further, at least two protrusions 3p, which protrude toward the inside of the contraction-side port 3b and extend in the axial direction up to the extension-side seat surface 3m, are provided to the outer peripheral surface 3g of each contraction-side port 3b.

Due to this configuration, when the damper 100 acts in the direction in which the disc valve 12 closes the contraction-side ports 3b, the disc valve 12 is supported by the protrusions 3p that protrude toward the inside of the contraction-side ports 3b. Thereby, the cross-section area of the contraction-side ports 3b can be increased, and bending of the disc valve 12 can be suppressed compared to the case in which the protrusions 3p are not provided, and thus the stress generated in the disc valve 12 can be reduced. Further, since two or more protrusions 3p are provided, the area of stress concentration in the disc valve 12 can be dispersed to the portions that abut the protrusions 3p, and the maximum stress that is generated in these portions that abut the protrusions can be decreased.

There are two protrusions 3p, and these two protrusions 3p are provided symmetrically relative to the center in the circumferential direction of the outer peripheral surface 3g.

Due to this configuration, the stress generated in each of the portions of the disc valve 12 that abut the two protrusions 3p can be made approximately equal. Therefore, the maximum stress that is generated in the portions of the disc valve 12 that abut the protrusions 3p can be decreased to the maximum degree.

The notch 3q is provided between the two protrusions 3p on the extension-side seat surface 3m so as to form an orifice passage between the notch 3q and the disc valve 12.

Due to this configuration, there is no overlap between the notch 3q and the protrusions 3p. Thus, variations in the passage length or passage shape of the orifice passage can be prevented, and the orifice characteristics can be stabilized.

Embodiments of the present invention were described above, but the above embodiments are merely examples of applications of the present invention, and the technical scope of the present invention is not limited to the specific constitutions of the above embodiments.

For example, in the above-described embodiment, hydraulic oil is used as the working fluid, but another liquid such as water or the like may be used.

Further, in the above-described embodiment, six extension-side ports 3a and six contraction-side ports 3b are provided to the piston 3, but the number of ports may be arbitrarily set as long as there are two or more.

In addition, in the above-described embodiment, the damper 100 is configured as a twin-tube damper, but the damper 100 may be configured as a mono-tube damper.

Moreover, in the above-described embodiment, the protrusions 3p are provided to the contraction-side ports 3b of the piston 3. However, the same configuration of the contraction-side ports 3b and the protrusions 3p may be applied to the extension-side ports of the piston and to the ports of the base member.

1. An annular piston for a damper, the piston comprising:
a plurality of ports formed along a circumferential direction of the piston, the ports penetrating in an axial direction of the piston; and
a plurality of seat surfaces, on which a disc valve is seated, formed to surround an opening of each port on one end surface of the piston, the disc valve being configured to open and close the ports,
wherein each port is defined by:
an arc-shaped inner peripheral surface;
an arc-shaped outer peripheral surface that is longer in a circumferential direction than the inner peripheral surface; and
two side surfaces that connect the inner peripheral surface and the outer peripheral surface, and
at least two protrusions are provided to the outer peripheral surface of each port, the protrusions protruding toward the inside of the port and extending in the axial direction up to the seat surface.

2. The piston according to claim 1, wherein the number of the protrusions are two and the two protrusions are provided symmetrically relative to a center in the circumferential direction of the outer peripheral surface.

3. The piston according to claim 2, wherein a notch is provided between the two protrusions on the seat surface, the notch forming an orifice passage between the notch and the disc valve.
